(19) United States
(12) Patent Application Publication
(10) Pub. No.: US 2016/0143315 A1
(43) Pub. Date: May 26, 2016

(54) DECORATIVE OBJECT

(71) Applicant: Heike SCHURICHT, Barcelona (ES)

(72) Inventor: Heike Schuricht, Barcelona (ES)

(21) Appl. No.: 14/904,372

(22) PCT Filed: Jul. 23, 2014
(86) PCT No.: PCT/ES2014/070590

§ 371 Date: Jan. 11, 2016

(30) Foreign Application Priority Data
Jul. 23, 2013 (ES) U201300683

(51) Int. Cl. A23G 3/56; A44C 15/00; A44B 15/00; A44C 9/00; A44C 25/00; A44C 7/00; A44C 5/00; A44C 1/00

(52) U.S. Cl. CPC A23G 3/563; A44C 5/0007; A44C 15/005; A44C 1/00; A44C 9/00; A44C 25/001; A44C 7/00; A44B 15/00

(57) ABSTRACT

The invention relates to a decorative object for forming a bracelet, armband, choker, necklace, brooch, ring, pendant, earrings, key ring or the like, or an item of clothing, comprising: a main body (1) made of a non-toxic, food-grade elastic material, wherein at least one receptacle (10) with a front mouth (103) is defined; and at least one edible product (2) with a suitable shape and dimensions for being inserted and extracted in a tightly fitting manner via the front mouth (103) of a receptacle (10) of the main body (1), and held inside said receptacle (10) by means of the pressure of the elastic material forming the main body (1).

### OBJECT OF THE INVENTION

The present invention relates to a decorative object, which has the particularity of allowing the incorporation of edible products in an improved and releasable manner.

### FIELD OF THE INVENTION

This invention is applicable in the manufacture of decorative objects for personal use.

### STATE OF THE ART

At present there are decorative objects available on the market, that incorporate edible products, such as candy that comes with holes strung onto an elastic band which is knotted at its ends to form a necklace, bracelet or similar.

Generally these decorative objects are worn surrounding a part of the wearer's body in direct contact with the skin and sweat, which carries a risk of contamination by bacteria and is hygienically inadequate. In addition, there is also a significant risk that the taste of these edible products may be altered by traces of soap, body lotions, perfumes or other products applied to the skin.

Moreover, the need to string the edible products determines that the decorative objects can only incorporate those edible products that have a composition that permits their perforation or that provide a hole to string them.

At present, and as a reference to the state of the art, it should be noted that the applicant is not aware of the existence of other decorative objects, for personal use, that have adequate configurations to incorporate edible products such as candy or gummies, individually and in hygienic conditions for consumption with the possibility of its extraction, without changing the structure of the decorative objects.

### SUMMARY OF THE INVENTION

The invention discussed herein provides a solution to the problems described above, consisting in a decorative object that has characteristics designed to allow the incorporation of edible products in the decorative object and their subsequent removal or replacement by the wearer in an easy and simple way, keeping the edible product from coming into direct contact with the wearer's skin and in adecuate hygienic conditions for consumption.

This decorative object can have different embodiments, including a bracelet, bangle, necklace, brooch, ring, pendant or any other decorative object and even an item of clothing as this does not affect the essence of the invention.

The decorative object subject to this invention comprises: a main body made of a non-toxic elastic material that is suitable for use in the food sector, with at least one receptacle with a front mouth defined within; and at least one edible product with a suitable shape and dimensions for being inserted and extracted in a tightly fitting manner through the front mouth of one receptacle of the main body and retained within said receptacle by means of the pressure of the elastic material forming the main body.

Said receptacle comprises a rear surface and a side wall defining the front mouth. The rear surface of said receptacle prevents the edible product, housed within, from coming into direct contact with the wearer's skin and therefore maintaining it in a hygienic condition for consumption.

The shape and dimensions of the edible product are suitable to allow its fitted introduction into one receptacle of the decorative object and its subsequent extraction by a simple elastic deformation of said receptacle. This solves the aforementioned drawbacks, since it is unnecessary that the edible product is provided with a hole to allow stringing; the receptacles accommodate any edible product of suitable shape and dimension, regardless of its composition.

In one embodiment of the invention the front mouth of the receptacle comprises on its inner circumference at least one abutment or lip suitable for holding an edible product within said receptacle, and in a position visible through said front mouth.

In order to improve the adjustment and fastening between the edible product and the respective receptacle, it is provided that said receptacle and the corresponding edible product may have in its rear area an appendix and a complementary recess to achieve complementary coupling.

The elastic material conforming the main body and the receptacle or receptacles defined therein, is preferably silicone for its properties: high moldability, nonstick and durable, easy to clean, non-toxic, odorless, tasteless, and not favoring the growth of mold and bacteria, however, it is to be understood that the use of other elastic, food-safe material suitable for this application is not excluded.

To facilitate the use of this decorative object it may comprise in its main body a supporting member, such as a ring, band or the like, defined in the elastic material of said main body, at least one attachment point suitable for receiving an external supporting member such as a band, string, strap, hook, link, ring or the like, or a suitable housing for the releasable coupling of an external clamping device such as a pin, clip or other.

### BRIEF DESCRIPTION OF THE DRAWINGS

To complement the description being made and in order to facilitate a better understanding of the characteristics of the invention, a set of drawings is appended hereto as an integral part thereof for an illustrative but not limited representation of the following:

FIG. 1 illustrates a top, front and side perspective view of an exemplary embodiment of the decorative object according to the invention, wherein the main body is forming a ring.

FIG. 2 illustrates a top plan view of the decorative object of FIG. 1 with the edible product housed in a receptacle of the main body.

FIG. 3 illustrates a bottom plan view of the decorative object of FIG. 1.

FIG. 4 illustrates a cross sectioned front elevation view of the decorative object of FIG. 1.

FIG. 5 illustrates a cross sectioned front elevation view of the receptacle that is elastically deformed during the introduction of an edible product.

FIG. 6 illustrates a view analogous to the previous illustration with the edible product inside the receptacle.

FIG. 7 illustrates a cross sectioned front elevation view of the receptacle that is elastically deformed during the extraction of the edible product.

FIG. 8 illustrates a cross sectioned front elevation view of an alternative embodiment of the decorative object shown in FIG. 1, in which the edible product and the receptacle of the main body provide in their rear area an appendix and a complementary recess for additional coupling.

FIG. 9 illustrates a top, front perspective view of an alternative embodiment of the decorative object, in this case forming a bracelet with a receptacle for housing an edible product.

FIG. 10 illustrates a bottom, front perspective view of the alternative embodiment of the decorative object of FIG. 9.

FIG. 11 illustrates a top, front perspective view of an alternative embodiment of the decorative object, forming a necklace and wherein the main body comprises a supporting member defined in the elastic material of said main body (1).

FIG. 12 illustrates an alternative embodiment of the decorative object forming a pendant, whose main body comprises an attachment point suitable for receiving an external band.

FIG. 13 illustrates a cross sectioned side elevation view of the main body of the decorative object of FIG. 12 sectioned along a vertical plane, illustrating the attachment point suitable for mounting an external band.

FIG. 14 illustrates a bottom plan view of an alternative embodiment of the decorative object according to the invention, forming a brooch whose main body comprises in its rear area a housing suitable for the releasable attachment of an external clamping device.

FIG. 15 illustrates a cross section side elevation view, of the embodiment of the decorative object represented in FIG. 14.

FIG. 16 illustrates a cross sectioned rear elevation view of the embodiment of the decorative object represented in FIG. 14.

### DETAILED DESCRIPTION AND BEST MODE OF IMPLEMENTATION

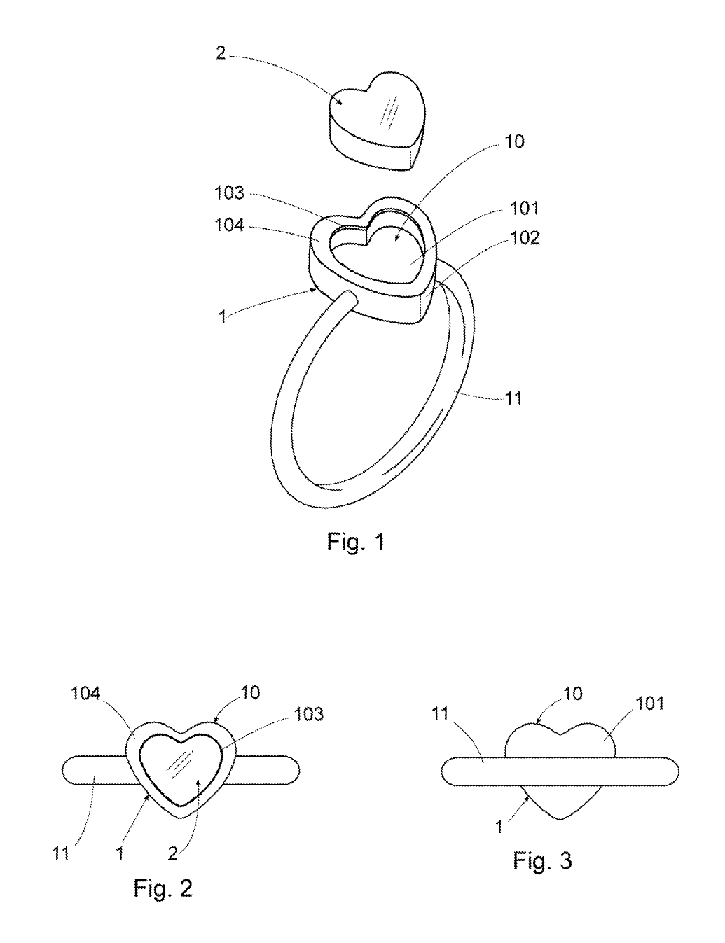

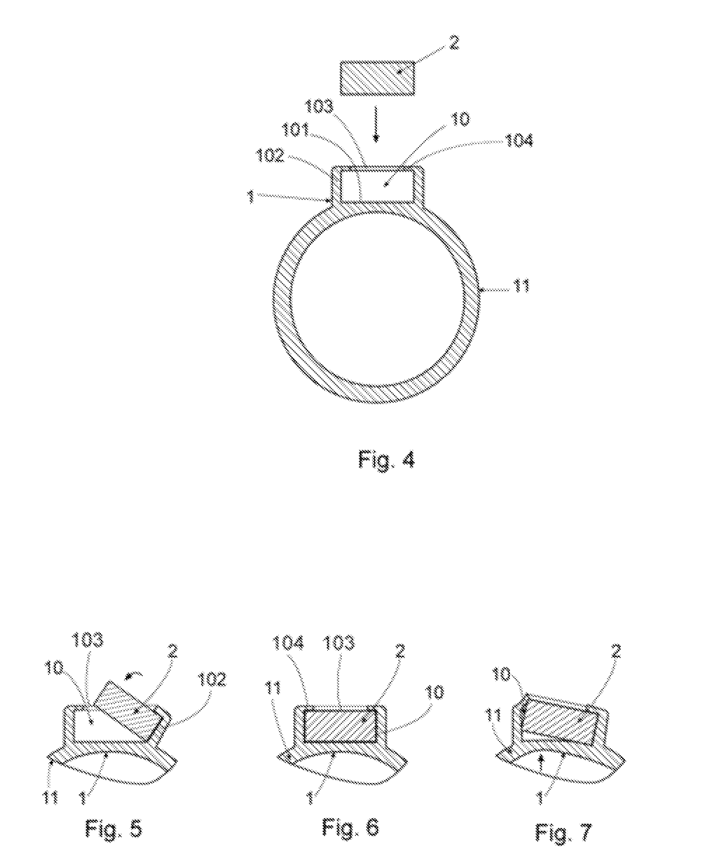

In the embodiment illustrated in FIGS. 1 to 4, the decorative object comprises a main body referenced in its entirety as (1), made of an elastic and nontoxic material, specifically in this case silicone, with a receptacle (10) defined in said main body (1) for the introduction and extraction of an edible product (2). In this embodiment the main body (1) further comprises a supporting member (11) formed as a continuous annular band in the elastic material of the main body (1) constituting the decorative object a ring.

The receptacle (10) comprises a rear surface (101) and a sidewall (102) defining a front mouth (103) for the introduction and removal of an edible product (2).

Said front mouth (103) comprises on its inner contour a lip or abutment (104) for holding the edible product (2) inside the receptacle (10).

As illustrated in FIGS. 5, 6 and 7 the introduction and removal of the edible product (2) inside the receptacle (10) is accomplished through the front mouth (103) and elastically deforming the side wall (102) of said receptacle (10).

After inserting the edible product (2) inside the receptacle (10) it is retained therein by the pressure of the elastic material forming the main body (1) and with the collaboration of the lip or abutment (104).

In the docking position, shown in FIGS. 2 and 6 the edible product is visible through the front mouth (103) of the receptacle (10).

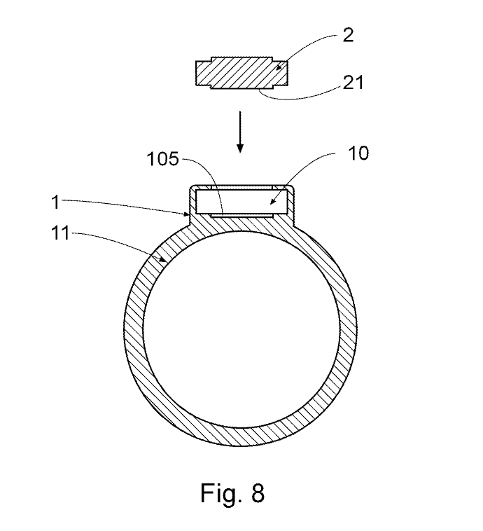

In the embodiment shown in FIG. 8 the receptacle (10) and the corresponding edible product (2) present on their facing surfaces a recess (105) and an appendix (21) for additional coupling.

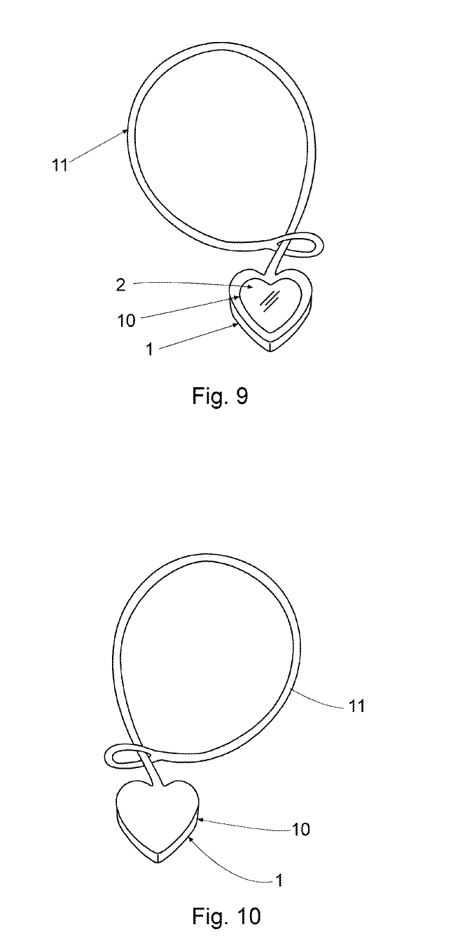

As illustrated in the alternative embodiments shown in FIGS. 9, 10 and 11 the supporting member (11) defined in the main body (1) of the decorative object can have different shapes depending on the type of decorative object to be formed.

Specifically in FIGS. 9 and 10 the supporting member, generically referenced as (11) and defined in the main body (1) presents a greater length than in the previous embodiment of the ring, forming in this case a bracelet.

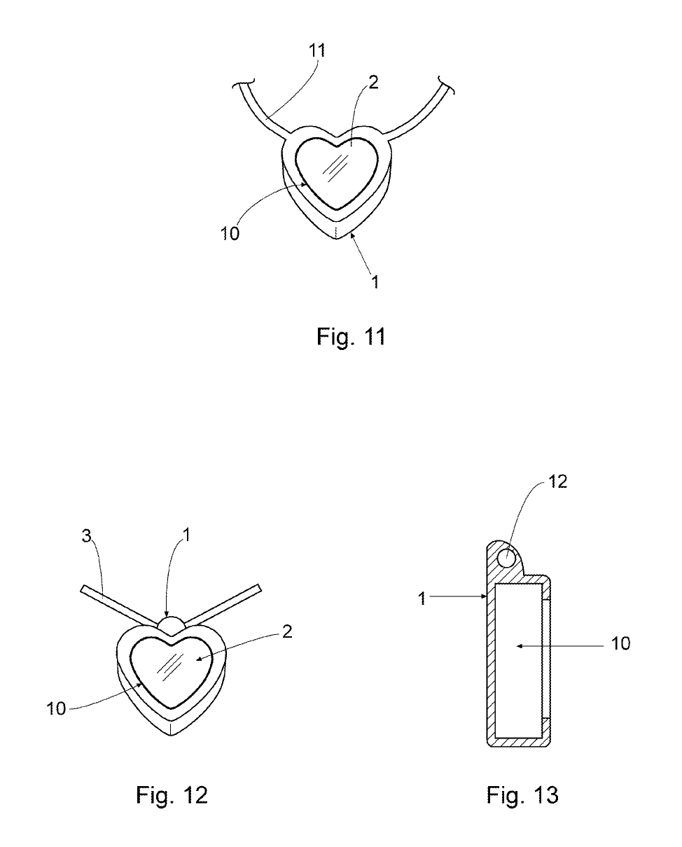

In the embodiment shown in FIG. 11 the supporting member defined in the elastic material of the main body (1) forms a band constituting the decorative object a necklace.

In the embodiment shown in FIGS. 12 and 13 the main body (1) comprises an attachment point (12) for mounting an external supporting member in this case represented by a band (3), constituting the decorative object a pendant.

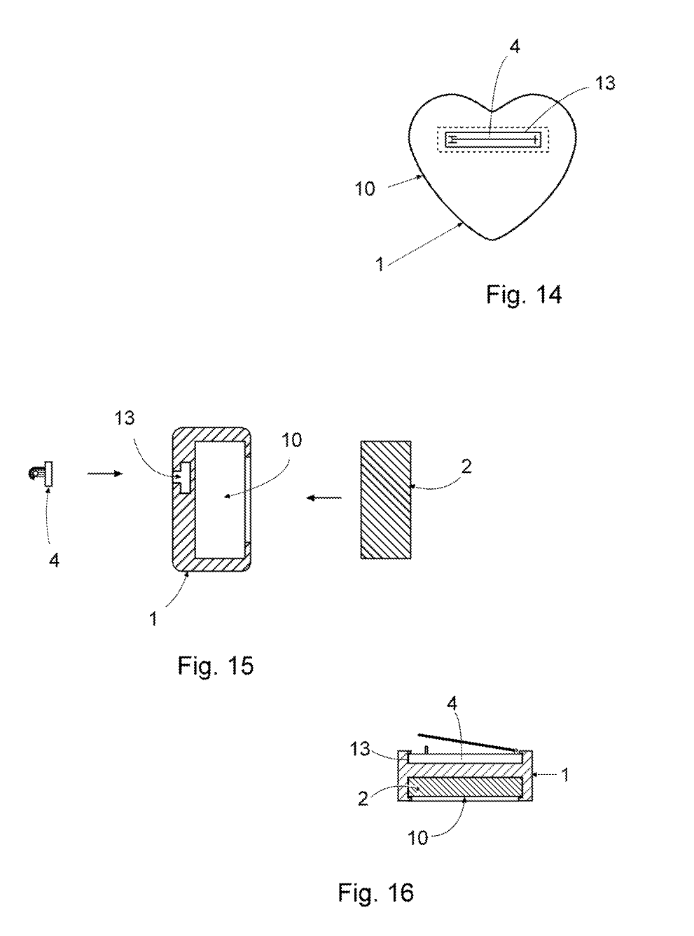

In the embodiment shown in FIGS. 14, 15 and 16 the main body (1) comprises a housing (13) opened towards the back and suitable for a releasable attachment of an external clamping device (4) represented in this case by a safety pin constituting the decorative object a brooch.

Once sufficiently described, the nature of the present invention and its preferred embodiment, it is stated for relevant purposes, that the materials, shape, size and arrangement of the elements described can be modified without departing from the spirit and scope of the present invention claimed below.

1. A decorative object suitable for forming a bangle, bracelet, necklace, brooch, ring, pendant, earrings, keychain or the like, or an item of clothing, comprising:—a main body (1) made of a non-toxic elastic material that is suitable for use in the food sector, with at least one receptacle (10) with a front mouth (103) defined within; and—at least one edible product (2) of suitable shape and dimensions for being inserted and extracted in a tightly fitting manner through the front mouth (103) of a receptacle (10) of the main body (1) and be retained within said receptacle (10) by means of the pressure of the elastic material forming the main body (1).

2. The decorative object according to claim 1, wherein at least one receptacle (10) comprises a rear surface (101) and a sidewall (102) defining the front mouth (103).

3. A decorative object according to any preceding claim, characterized in that the front mouth (103) comprises on its inner circumference at least one lip or abutment (102) suitable for holding the edible product (2) inside the receptacle (10) at a position visible through said front mouth (103).

4. A decorative object according to any preceding claim, characterized in that at least one receptacle (10) and a corresponding edible product (2) present on facing surfaces a recess (105) and an appendix (21) for complementary coupling.

5. A decorative object according to any preceding claim, characterized in that the elastic material conformant of the main body (1) is food-grade silicone.

6. A decorative object according to any of claims 1 to 5, characterized in that the main body (1) comprises a supporting member (11) type ring, band or similar defined in the elastic material of said main body (1).

7. A decorative object according to any of claims 1 to 5, characterized in that the main body (1) comprises at least one attachment point (12) suitable for mounting an external supporting member (3) such as a string, band, hook, link, ring or similar.

8. A decorative object according to any of claims 1 to 5, characterized in that the main body (1) comprises at least one housing (13) suitable for the releasable attachment of an external clamping device (4), such as a pin, a clamp or similar.
